(19) United States
(12) Patent Application Publication
(10) Pub. No.: US 2024/0190227 A1
(43) Pub. Date: Jun. 13, 2024

(54) DRIVE AXLE OF AN ELECTRICALLY OPERABLE MOTOR VEHICLE

(71) Applicant: Dr. Ing. h.c. F. Porsche Aktiengesellschaft, Stuttgart (DE)

(72) Inventors: Johannes LANGE, Dettenheim (DE); Daniel KNOBLAUCH, Leonberg (DE); Tobias ENGELHARDT, Stuttgart (DE)

(21) Appl. No.: 18/525,999

(22) Filed: Dec. 1, 2023

(30) Foreign Application Priority Data
Dec. 9, 2022 (DE) 10 2022 132 778.7

(51) Int. Cl. B60K 1/02; B60K 23/08

(52) U.S. Cl. CPC B60K 1/02; B60K 23/0808; B60K 2023/0841; B60K 2023/0858

(57) ABSTRACT

A drive axle of an electrically operable motor vehicle includes a drivetrain group having a first drivetrain and a second drivetrain, wherein each of the first drivetrain and the second drivetrain is designed as a single-wheel drive and includes an electric machine and a transmission having at least two transmission stages. The first and second drivetrains are connectable to respective driven shaft assemblies, which generate an output, by a differential lock. The differential lock includes a clutch arrangement having a clutch actuator, which is configured to induce a closing flow of force within one of the two driven shaft assemblies.

### CROSS REFERENCE TO RELATED APPLICATIONS

This application claims benefit to German Patent Application No. DE 10 2022 132 778.7, filed on Dec. 9, 2022, which is hereby incorporated by reference herein.

### FIELD

The invention relates to a drive axle of an electrically operable motor vehicle.

### BACKGROUND

Drive axles of electrically operable motor vehicles are known and can also be referred to as radius-specific drives, because the drive axle, which is designed to drive a first wheel and a second wheel, comprises two separate drivetrains for each of the wheels. The drivetrains can have an axially parallel or coaxial design. The drivetrains provide a generally functionally independent drive for each wheel, so that wheel-specified wheel torques, drive outputs, and speeds can be adjusted or regulated.

Typically, with such drive systems, an additional power and wheel torque demand going beyond pure longitudinal performance as is the case when, e.g., torque vectoring is used (in this context, e.g., higher torques are applied to the outward wheels) can only be achieved insofar as torque and power reserves have been taken into account in the corresponding design of e-machines, pulse inverters, and transmissions.

Publication CN 105459781 A discloses two single-wheel drives, each having an electric machine and a transmission, whereby transmission output shafts of the single-wheel drives are connectable to one another by means of a clutch arrangement.

A drive axle of an electric vehicle is known from publication DE 10 2009 013 875 B4, in which the drive axle comprises two single-wheel drives, each having an electric machine and a transmission, and in which the two gearwheels of the transmissions of the single-wheel drives generating the output are axially supported against each other and arranged opposite one another with helical teeth.

Two single-wheel drives, each having an electric machine and a transmission, can be gathered from document DE 10 2011 076 279 A1, in which transmission output shafts of the single drives are connectable by means of a clutch arrangement, in which case the clutch arrangement can be designed as a jaw clutch or a slip clutch.

Publication DE 10 2018 221 601 A1 discloses two single-wheel drives, each having an electric machine and a multi-gear manual transmission, in which transmission driven shafts of the single drives are connectable to each other by means of an electrically regulatable multi-plate clutch.

Publication DE 102 48 173 A1 is based on two single-wheel drives, each having an electric machine and a transmission, whereby the transmission output shafts or the transmission input shafts of the single drives are connectable to one another by means of a multi-plate clutch or a jaw clutch.

Publication JP 2017178010 A also discloses two single-wheel drives, each having an electric machine and a multi-gear manual transmission, in which the transmission output shafts of the single drives are connectable by means of a clutch.

Known from publication US 2013/0030636 A1 are two single-wheel drives, each having an electric machine and a transmission, in which the respective electric machine is driven by a drive shaft connected to a vehicle wheel via the respective transmission, and in which the drive shafts are connectable to one another via a clutch.

Known from publications US 2021/0379977 A1 and US 2021/0381587 A1 are two single-wheel drives, each having an electric machine and a transmission, in which transmission output shafts of the single drives are connectable to each other by means of a clutch, and in which the clutch is partially integrated into a gearwheel of a transmission output shaft.

### SUMMARY

In an embodiment, the present disclosure provide a drive axle of an electrically operable motor vehicle, comprising a drivetrain group having a first drivetrain and a second drivetrain, wherein each of the first drivetrain and the second drivetrain is configured as a single-wheel drive and comprises an electric machine and a transmission having at least two transmission stages. The first and second drivetrains are connectable to respective driven shaft assemblies, which generate an output, by a differential lock. The differential lock comprises a clutch arrangement having a clutch actuator, which is configured to induce a closing flow of force within one of the two driven shaft assemblies.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates, in a side view, a drive axle of an electrically operable motor vehicle according to the prior art;

FIG. 2 illustrates, in a side view, a drive axle of the electrically operable motor vehicle according to an embodiment of the invention with a drivetrain group with a differential lock;

FIG. 3 illustrates, in a longitudinal section, driven shaft assemblies of the drive axle according to the embodiment shown in FIG. 2;

FIG. 4 illustrates, in a perspective view, the driven shaft assemblies of the drive axle according to the embodiment shown in FIG. 3; and

FIG. 5 illustrates, in a longitudinal section, a receiving driven shaft assembly of the drive axle according to an embodiment of the invention with a clutch arrangement.

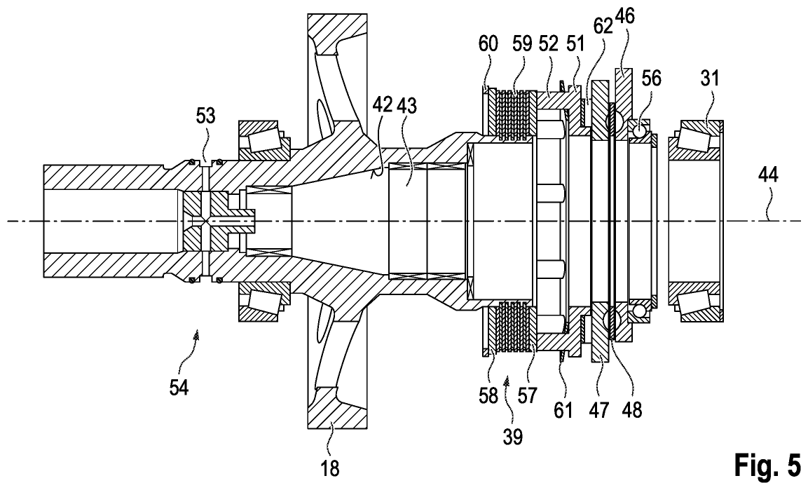

### DETAILED DESCRIPTION

In an embodiment of the invention, two drivetrains for power and torque distribution are connected together, at least in part and/or at times, so that a correspondingly required power and torque flow can be achieved, whereby a flow of force acting on the transmission is designed in the form of a closed flow of force, in particular reliably.

In an embodiment, the present invention provides an improved drive axle of an electrically operable motor vehicle.

A drive axle of an electrically operable motor vehicle according to an embodiment of the present invention comprises a drivetrain group having a first drivetrain and a second drivetrain, each drivetrain being designed as a single-wheel drive, and comprising an electric machine and a transmission having at least two transmission stages. According to an embodiment of the invention, the drivetrains are connectable to their driven shaft assemblies by means of a differential lock, the differential lock comprising a clutch arrangement having a clutch actuation means designed to induce a closing flow of force within one of the two driven shaft assemblies. The advantage of the drive axle according to embodiments of the invention is evident in that, by means of the closed flow of force on only one of the two drive shaft assemblies, a secured connection of the two drivetrains is achieved, which can also be quickly released as needed without influencing the force, in particular negatively influencing the force, on the remaining components of the drivetrain group. For example, a drivetrain group can, e.g., be employed with axial force compensation, whereby the axial force compensation remains unaffected by the clutch by means of the differential lock. The efficiency advantages of such powertrain groups can thereby be retained.

A further advantage of this drive axle according to an embodiment of the invention is that, due to the concentration of the flow of force on the driven shaft assemblies and in particular on only one of the two driven shaft assemblies, further components of the two drivetrains are not subjected to additional loads given a power and torque distribution by means of the transverse interlock.

A further advantage is evident in an achievable, high degree of stiffness of the drivetrain group, which can lead to a preferable carrying capacity and acoustics in transmissions in the form of gearwheel transmissions because any tilting of gearwheels and deviations in rotational travel can be effectively avoided.

In a preferred embodiment of the drive axle according to the invention, the clutch actuation means is designed in the form of a ball ramp actuation means, which can secure an axial flow of force, and thus the possible axial force compensation.

Further secured tilting avoidance can be achieved insofar as a driven shaft of one of the two driven shaft assemblies is designed to at least partially receive a driven shaft of the other of the two driven shaft assemblies. A bearing concept can thereby be induced that reduces tilting of the gearwheels to a minimum.

A drivetrain group with axial force compensation is achievable insofar as gearwheels formed on the respective driven shaft assembly axially support each other and are formed opposite one another with helical teeth.

A space-optimized drive axle including the further axial force compensation security by means of the closed flow of force can be provided insofar as a clutch of the clutch assembly is received in one of the gearwheels.

The clutch of a multi-plate clutch is in particular advantageous for the effective transmission of force.

A preferred embodiment of the drive axle according to the invention is achieved insofar as the clutch actuation means is connected to the actuator, in particular by means of a further transmission. The advantage is apparent in a secured, controllable, and therefore regulated differential lock. A simple and cost-efficient solution is in this case provided by an actuator which is designed in the form of a positioning motor.

Using the drive axle according to an embodiment of the invention, torque and power can be secured and quickly directed from a single-wheel drive, in particular to one wheel of the other single-wheel drive, this being possible during motor and/or generator operation of the drivetrains.

Additional advantages, features, and details of embodiments of the invention arise from the following description of preferred exemplary embodiments, as well as with reference to the drawings. The features and feature combinations specified hereinabove in the description, as well as the features and feature combinations mentioned hereinafter in the description of the drawings and/or shown alone in the drawings, can be used not only in the respectively specified combination, but also in other combinations, or on their own, without departing from the scope of the invention. Identical or functionally identical elements are assigned identical reference signs. Shown are:

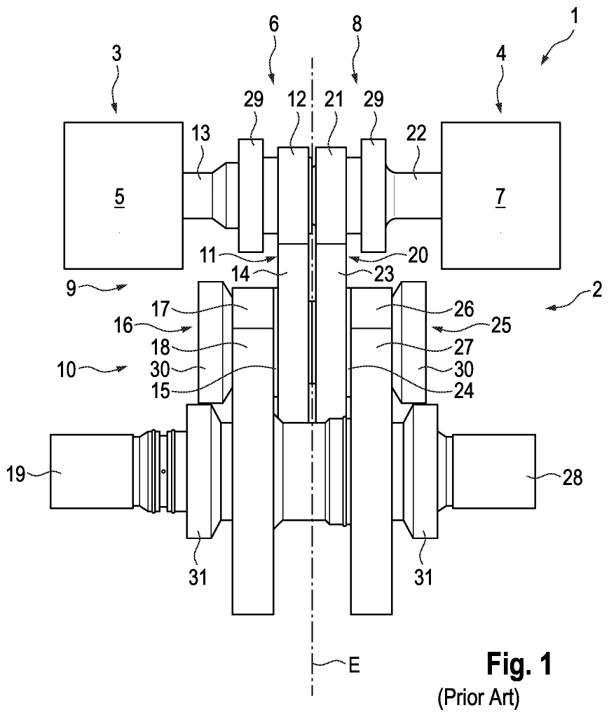

A drive axle 1 for an electrically operable motor vehicle according to the prior art is structured as shown in FIG. 1. The drive axle 1 comprises a drivetrain group 2, which is formed from a first drivetrain 3 and a second drivetrain 4. Each drivetrain 3; 4 is designed as a single-wheel drive and can operate independently, therefore independent of the adjacent drivetrain 4; 3. For this purpose, the first drivetrain 3 comprises a first electric machine 5 and a first transmission 6. The second drivetrain 4 comprises a second electric machine 7 and a second transmission 8.

Each of the transmissions 6, 8 comprises two transmission stages, a first transmission stage 9 and a second transmission stage 10, whereby the transmissions 6, 8 are designed in the form of gearwheel transmissions. To form its first transmission stage 9, the first transmission 6 comprises a first gearwheel pair 11, which comprises a first gearwheel 12 having a first drive shaft 13 and a second gearwheel 14 2 on a first intermediate shaft 15. Furthermore, to form its second transmission stage 10, the first transmission 6 comprises a second gearwheel pair 16, which comprises a third gearwheel 17 on the first intermediate shaft 15 and a fourth gearwheel 18 having a first driven shaft 19.

The second transmission 8 is designed almost the same, but in mirror form along an axis of extension E of the drivetrain group 2. To form its first transmission stage 9, the second transmission 8 comprises a third gearwheel pair 20, which comprises a fifth gearwheel 21 having a second drive shaft 2 and a sixth gearwheel 23 on a second intermediate shaft 24. Furthermore, to form its second transmission stage 10, the second transmission 8 has a fourth gearwheel pair 25, comprising a seventh gearwheel 26 on the second intermediate shaft 17 and an eighth gearwheel 27 with a second driven shaft 28. The fourth gearwheel 18, along with its first driven shaft 19, will be referred to as the first driven shaft assembly 35, and the eighth gearwheel 27, along with the second driven shaft 28, will be referred to as the second driven shaft assembly 36. The transmissions 6, 7 could also feature more than two transmission stages 9, 10.

The first drive shaft 13 and the second drive shaft 22 are designed to be coaxial and comprise a common first bearing arrangement 29. Likewise, the first intermediate shaft 15 and the second intermediate shaft 24 are designed to be coaxial and comprise a common second bearing arrangement 30. Furthermore, the first driven shaft 19 and the second driven shaft 22 are also designed to be coaxial and comprise a common third bearing arrangement 31. The bearing arrangements 29, 30, 31, in particular the third bearing arrangement 31, comprise rolling bearings, in particular in the form of helical roller bearings.

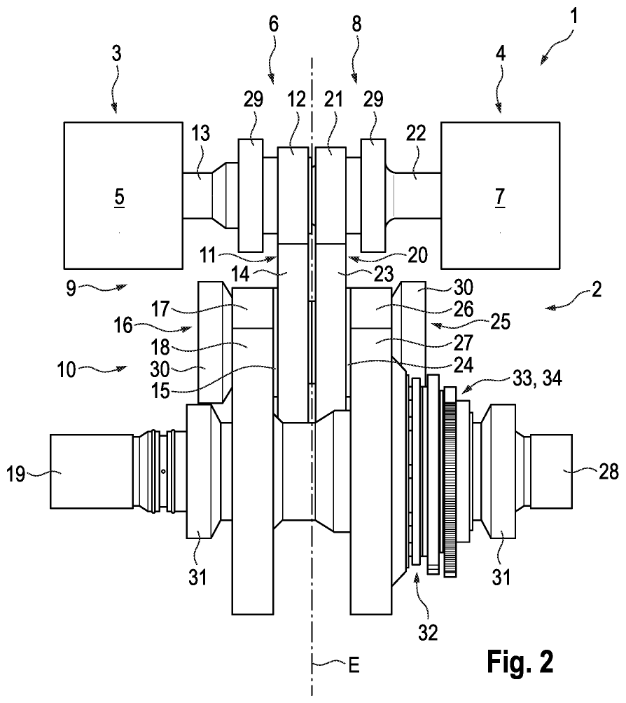

In FIG. 2, the drive axis 1 according to an embodiment of the invention is illustrated along with its drivetrain group 2. The two drivetrains 3, 4, each of which is designed as a single-wheel drive, are, by means of a transverse interlock 32, connectable to their second transmission stages 10, which comprise the first driven shaft 19 of the first drivetrain 3 and the second driven shaft 28 of the second drivetrain 4. Or, in other words, the first driven shaft assembly 35 is connectable to the second driven shaft assembly 36 in a rotationally fixed manner by means of the differential lock 32 in order to transmit a torque.

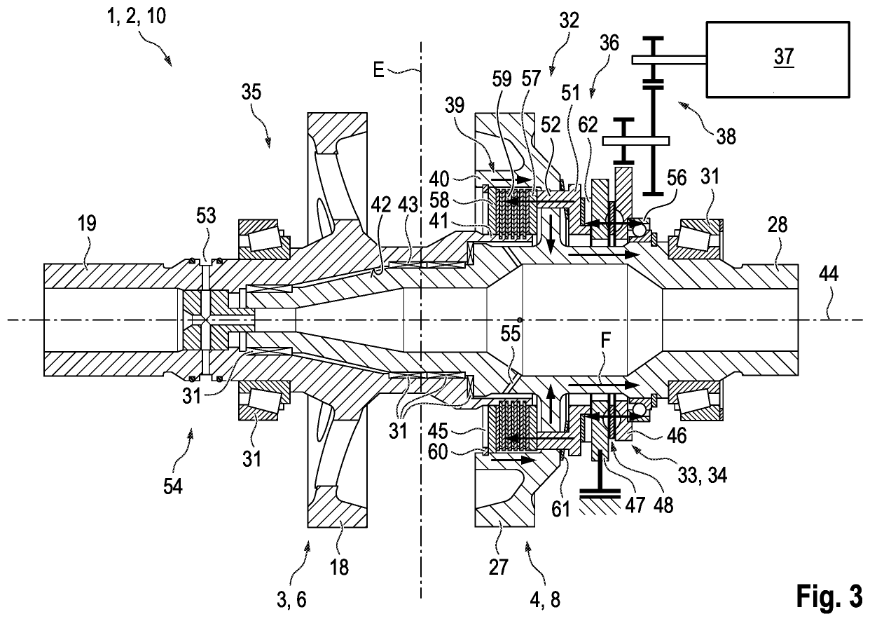

The differential lock 32 comprises a clutch arrangement 33 having a clutch actuation means 34 designed to induce a closing flow of force F within one of the two driven shaft assemblies 35, 36, which is illustrated in FIG. 3 by directional arrows. In the present exemplary embodiment, this is preferably the second driven shaft assembly 36, on the side of which an actuator 37 of the clutch arrangement 33 is formed in order to actuate the clutch actuation means 34. The flow of force F is only generated between the clutch arrangement 33, the clutch actuation means 34, and the second driven shaft assembly 35. The second driven shaft assembly 36, which is at least partially received in the first driven shaft assembly 35, is therefore designed to induce the closing flow of force F.

The closing flow of force F generated within one of the two driven shaft assemblies 35, 36 (in the present embodiment, the second driven shaft assembly 36) can be induced in an advantageous manner insofar as the gearwheels 18, 28 of the driven shaft assemblies 35, 36 (in particular, however, all gearwheels 12, 14, 17, 18, 21, 24, 26, 27 of the transmission 6, 8) support each other axially and are formed opposite one another with helical teeth, as illustrated in the principle representation in FIG. 2 by a line formed obliquely to the axis of extension E.

The clutch actuation means 34 is designed in the form of a ball ramp actuation means, which is configured to induce the closed flow of force F acting on the second driven shaft assembly 34. The clutch actuation means 34 is controlled using the actuator 37, which is designed in the form of a positioning motor. A further transmission 38 is formed between the actuator 37 and the clutch actuation means 34 in order to improve control of the clutch actuation means 34, whereby the further transmission 38 is also designed in the form of a gearwheel transmission. Said transmission could also be designed in the form of a belt transmission, or in a different form.

The differential lock 32 comprises the clutch arrangement 33 comprising a clutch 39 in the form of a multi-plate clutch, whereby an outer plate support 40 of the clutch 39 of the second driven shaft 28 and an inner plate support 41 of the clutch 39 are associated with the first driven shaft 19.

The first driven shaft 19 is at least partially receivable by the second driven shaft 28. In other words, the driven shaft 19; 28 of one of the two driven shaft assemblies 35, 36 is designed to at least partially receive the driven shaft 28; 19 of the other of the two driven shaft assemblies 36, 35. For this purpose, the first driven shaft 19, on which the fourth gearwheel 18 is received in a rotationally fixed manner by the first driven shaft 19, is at least partially hollow (but completely hollow in the present exemplary embodiment). Said shaft comprises inner bearings 43 on its inner surface 42, preferably in the form of needle bearings, for further support of the second driven shaft 28, so that the latter can rotate relative to the first driven shaft 19 about a common longitudinal axis 44 when the differential lock 32 is open. Another shape for the inner bearings 43 would also be conceivable, e.g., sliding bearings.

The second driven shaft 28, which is partially received in the first driven shaft 19, is also hollow, so flow can take place through it. The clutch 39 is received in the eighth gearwheel 27, therefore in a receiving opening 45 which is formed in the eighth gearwheel 27, between a lateral surface of the eighth gearwheel 27 and the second driven shaft 28.

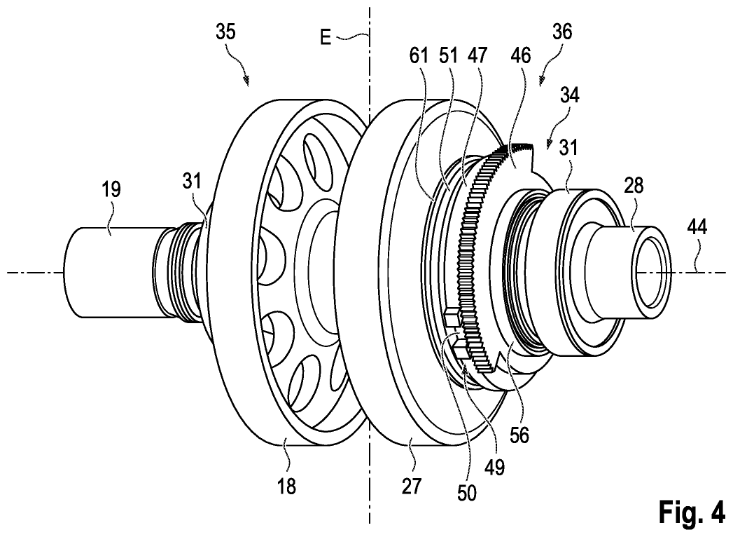

The clutch actuation means 34, which is designed in the form of the ball ramp actuation means, comprises a first annular disc 46, which at least partially comprises teeth on its outer circumference for engagement of the further transmission 38, and a second annular disc 47 opposite the first annular disc 46 in the form of a thrust ring, in which case balls 48 of the ball ramp actuation means 34 are arranged between the first annular disc 46 and the second annular disc 47. The second annular disc 47 is secured by means of a securing means 49 in the form of a groove 50 formed in the second annular disc 47 (as can be seen in FIG. 4) and a retaining element, which is receivable in the groove 50 in order to secure against rotation about the longitudinal axis 44.

The second annular disc 47 is further designed as a track of an axial needle bearing 62, which is arranged between the second annular disc 47 and a pressure ring 51. The pressure ring 51 comprises pressure bolts 52, which extend in the axial direction and are designed to be contactable by the clutch 39 for the transmission of force. The pressure ring 51 comprises, for the uniform transmission of force over its perimeter, the pressure bolts 52 arranged at a regular distance from one another. Said ring is also designed as a raceway of the axial needle bearing 62.

Actuation of the clutch actuation means 34 moves the pressure ring 51 in the axial direction, towards the clutch 39, so that the pressure bolts 52 can act on the clutch 39 in a force transmitting manner. In the present example, the clutch 39 is designed in the form of a multi-plate clutch and comprises a first pressure plate 57 arranged opposite the pressure ring 51 for force application using the pressure bolts 52. Between the first pressure plate 57 and a second pressure plate 58 of the multi-plate clutch 39, plates 59 of the outer plate support 40 and plates 59 of the inner plate support 41 are preferably alternately arranged in a force transmitting manner. To axially secure the clutch 39, a securing element 60 in the form of a snap ring is arranged on the second pressure plate 58, facing away from the vanes 59.

To lubricate and cool the inner bearings 43 or the differential lock 32, the first end region 54 of the first driven shaft 19 facing away from the second driven shaft 28 comprises a passage opening 53. Via this passage opening 53, lubricant, which is also used as a coolant, can flow into the first driven shaft 19, which is designed to be hollow, and the second driven shaft 28, which is designed to be hollow, via the inner bearings 43 and via a through-flow channel 55 formed in the second driven shaft 28, which channel penetrates towards the clutch 39. Advantageously, the differential lock 32, the first driven shaft assembly 35, and the second driven shaft assembly 36 can thereby be lubricated and cooled.

The clutch actuation means 34 is axially secured to the first ring pulley 46 by means of an counter bearing 56 in the form of a fixed-seat ball bearing on the second driven shaft 28. A spring element 61 in the form of a spring washer is arranged between the eighth gearwheel 27 and the pressure ring 51 in order to open the differential lock 23 and to adjust the same.

The shafts 13, 15, 19 of the transmission stages 9, 10 of the first drivetrain 3 are preferably designed to receive the respective coaxially formed shafts 22; 24; 28 of the second drivetrain 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Drive axle
Drivetrain group
First drivetrain
Second drivetrain
First electric machine
First transmission
Second electric machine
Second transmission
First transmission stage
Second transmission stage
First gearwheel pair
First gearwheel
First drive shaft
Second gearwheel
First intermediate shaft
Second gearwheel pair
Third gearwheel
Fourth gearwheel
First driven shaft
Third gearwheel pair
Fifth gearwheel
Second drive shaft
Sixth gearwheel
Second intermediate shaft
Fourth gearwheel pair
Seventh gearwheel
Eighth gearwheel
Second driven shaft
First bearing arrangement
Second bearing arrangement
Third bearing arrangement
Differential lock
Clutch arrangement
Clutch actuation means
First driven shaft assembly
Second driven shaft assembly
Actuator
Additional transmission
Clutch
Outer plate support
Inner plate support
Inner surface
Inner bearing
Longitudinal axis
Receiving opening
First annular disc
Second annular disc
Ball
Securing means
Groove
Pressure ring
Pressure bolt
Passage opening
End region
Through-flow channel
Counter bearing
First pressure plate
Second pressure plate
Plate
Securing element
Spring element
Axial needle bearing
E Extension axis
F Flow of force

1. A drive axle of an electrically operable motor vehicle, comprising:
a drivetrain group having a first drivetrain and a second drivetrain, wherein each of the first drivetrain and the second drivetrain is configured as a single-wheel drive and comprises an electric machine and a transmission having at least two transmission stages,
wherein the first and second drivetrains are connectable to respective driven shaft assemblies, which generate an output, by a differential lock,
wherein the differential lock comprises a clutch arrangement having a clutch actuator, which is configured to induce a closing flow of force within one of the two driven shaft assemblies.

2. The drive axle according to claim 1, wherein the clutch actuator is configured as a ball ramp actuator.

3. The drive axle according to claim 1, wherein a driven shaft of one of the two driven shaft assemblies is configured to at least partially receive one driven shaft of the other of the two driven shaft assemblies.

4. The drive axle according to claim 3, wherein the driven shaft assembly, which is configured to be at least partially received, is configured to induce the closing flow of force.

5. The drive axle according to claim 1, wherein the transmissions are configured as gearwheel transmissions.

6. The drive axle according to claim 5, wherein gearwheels formed on the respective driven shaft assembly of the transmissions axially support one another and are formed opposite one another with helical teeth.

7. The drive axle according to claim 6, wherein a clutch of the clutch arrangement is received in one of the gearwheels.

8. The drive axle according to claim 7, wherein the clutch is a multi-plate clutch.

9. The drive axle according to claim 1,
wherein
the clutch actuator is connected to a second actuator by a further transmission.

10. The drive axle according to claim 9, wherein the second actuator is a positioning motor.

11. The drive axle according to claim 9, wherein the further transmission is a gearwheel transmission.

12. The drive axle according to claim 1, wherein shafts of the at least two transmission stages of the first or the second drivetrain are respectively configured to receive a coaxially formed shaft of the other of the first and second drivetrain.

13. The drive axle according to claim 1, wherein the at least two transmission stages of the transmissions each comprise a common bearing arrangement.
